(19) United States
(12) Patent Application Publication
(10) Pub. No.: US 2024/0349415 A1
(43) Pub. Date: Oct. 17, 2024

(54) LOW-TEMPERATURE PLASMA CONTROL SYSTEM

(71) Applicant: SirenOpt Inc., Oakland, CA (US)

(72) Inventors: Ali MESBAH, Danville, CA (US); Jared O'LEARY, Oakland, CA (US); Kimberly Jingying CHAN, Berkeley, CA (US)

(21) Appl. No.: 18/743,057

(22) Filed: Jun. 13, 2024

Related U.S. Application Data
(63) Continuation of application No. PCT/US2024/024008, filed on Apr. 11, 2024.
(60) Provisional application No. 63/507,860, filed on Jun. 13, 2023.
(60) Provisional application No. 63/507,855, filed on Jun. 13, 2023.
(60) Provisional application No. 63/496,110, filed on Apr. 14, 2023.

(51) Int. Cl. H05H 1/00; H05H 1/26

(52) U.S. Cl. CPC H05H 1/0006; H05H 1/26; H05H 2245/40

(57) ABSTRACT

A plasma system comprising a low temperature plasma source incident on a material sample and a plurality of sensors that measure a plurality of different characteristics of the plasma. The plasma system further comprising a feedback control system that receives measurements from the plurality of sensors and adjusts inputs to the low temperature plasma source to control one or more of physical, electrical, electromagnetic, chemical, or thermal characteristics of a plasma generated, at a sub-second rate.

### RELATED CASES

The present application claims priority to U.S. Provisional Application 63/507,860 filed on Jun. 13, 2023, U.S. Provisional Application 63/507,855 filed on Jun. 13, 2023, and PCT Application No. PCT/US24/24008, filed on Apr. 11, 2024, which claims priority to U.S. Provisional Application No. 63/496, 110, filed on Apr. 14, 2023, each of which is incorporated by reference in its entirety.

### FIELD

The present invention relates to low-temperature plasma and a control system for low temperature plasma.

### BACKGROUND

Low-temperature plasma is usually generated by applying an electric field across electrodes to a gas. The resulting plasma is a quasi-neutral medium composed of positive and negative ions, electrons, photons and neutral (reactive) species. Low-temperature plasma has been used in characterizing or treating materials. However, low-temperature plasma sources are prone to inconsistencies due to environmental factors and target material properties causing variations in the plasma, which can damage the materials being treated or characterized.

### BRIEF DESCRIPTION OF THE FIGURES

The present invention is illustrated by way of example, and not by way of limitation, in the figures of the accompanying drawings and in which like reference numerals refer to similar elements and in which:

FIG. 1 is an overview illustration of one embodiment of a low temperature plasma system.

FIG. 2 is an overview block diagram of one embodiment of a control system for plasma.

FIG. 3 is one embodiment of a sensor set up for the low temperature plasma system.

FIG. 4 is a circuit diagram of one embodiment of the low temperature plasma system.

FIG. 5 is an overview flowchart of one embodiment of using the low temperature plasma system.

FIG. 6 is a flowchart of one embodiment of setting up the low temperature plasma system.

FIG. 7 is a diagram of one embodiment of the hierarchical control system for the low temperature plasma system.

FIG. 8 is a flowchart of one embodiment of using the hierarchical control system.

FIG. 9 is a diagram of one embodiment of the training for a deep neural network that may be used with the low temperature plasma system.

FIG. 10 is a block diagram of a computer system that may be used with the low temperature plasma system.

### DETAILED DESCRIPTION

Low-temperature plasmas may be used in a wide range of interactions with a material, such as treating, modifying, or etching of materials as well as for surface characterization. The low-temperature plasma system provides a low-temperature plasma and a method and apparatus to control the plasma and the plasma-material interactions. In one embodiment, the low-temperature plasma source is an atmospheric pressure plasma jet (APPJ). The APPJ discharges a low-temperature plasma that is incident on a material. The power and interaction of the low-temperature plasma with the material is controlled by a set of parameters, such as the rate of flow of gas (in one embodiment helium), the power applied, the waveform used, the distance between the plasma and the material.

It is desirable for the characteristics of the low-temperature plasma to be consistent, so the material is not damaged by the treatment or characterization. However, many manufacturing and testing processes occur in ambient conditions (rather than in vacuum chambers) and the power output of the low-temperature plasma source can be impacted by environmental factors, such as temperature, humidity, drafts, or other air disturbances, such as those caused by the movement of machines or people in the environment, etc. Additionally, variations in the target surface/material and the time-varying nature of the plasma and surface characteristics can impact the power output. To address these problems, various embodiments use a feedback control system that receives data from a variety of sensors and adjusts the source parameters in real-time to maintain the plasma characteristics. The sensors in one embodiment measure the power of the low-temperature plasma, in one embodiment by taking voltage and current measurements. The feedback control system in one embodiment adjusts the source parameters by modifying the applied voltage and/or frequency, and/or gas flow, to stabilize the power output. Additionally, or alternatively, using this feedback control system in conjunction with other elements of the system such as data collection may enable safe, effective, and automated control of plasma interactions with a material. For example, precise organic and inorganic materials processing may be performed by controlling the power of the plasma to match a desired power profile as the plasma source is moved relative to the material.

The following detailed description of embodiments of the invention make reference to the accompanying drawings in which like references indicate similar elements, showing by way of illustration specific embodiments of practicing the invention. Description of these embodiments is in sufficient detail to enable those skilled in the art to practice the invention. One skilled in the art understands that other embodiments may be utilized, and that logical, mechanical, electrical, functional, and other changes may be made without departing from the scope of the present invention. The following detailed description is, therefore, not to be taken in a limiting sense, and the scope of the present invention is defined only by the appended claims.

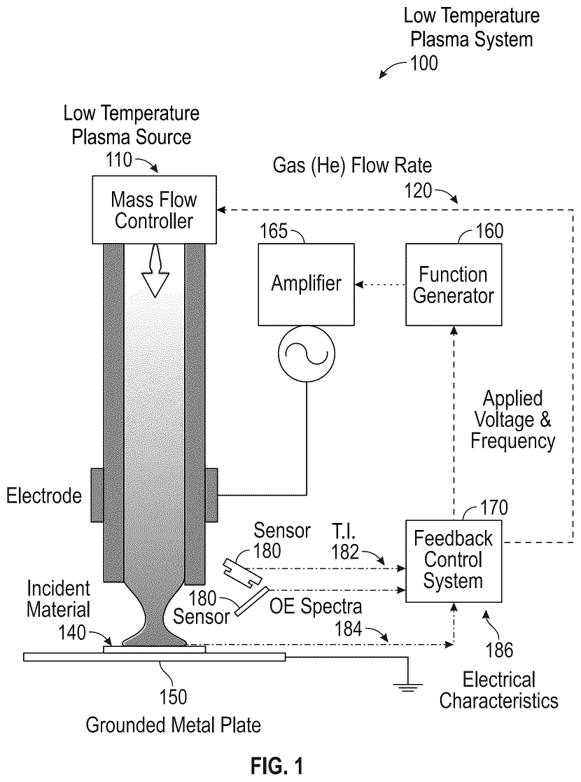

FIG. 1 is an overview illustration of one embodiment of a low temperature plasma system. The plasma system includes a low temperature plasma source 110, which is controlled by a combination of gas flow rate 120 and applied voltage and frequency. The plasma is incident on a material 140 which rests on a grounded metal plate 150, in one embodiment. The plasma may be used for characterizing the incident material 140, etching the incident material 140, treating the incident material 140, or otherwise modifying the incident material 140.

The low temperature plasma source 110 receives control signals from a function generator 160, which may be amplified by amplifier 165. In one embodiment, the low-temperature plasma source 110 is a cold atmospheric plasma source producing a low temperature plasma close to room temperature at atmospheric pressure.

The function generator 160 in one embodiment generates a signal used to drive the amplifier. The function generator 160 receives control signals from the feedback control system 170, which calculates the voltage and frequency to be applied to the low temperature plasma source 110.

The feedback & control system 170 receives sensor data from sensors 180. In one embodiment the sensor data collects data from one or more of the plasma plume, the interface between the plasma plume and the material, and from the material (collectively the region). The sensor data may include a thermal image (T.I) 182, optical emission (O.E.) spectra 184, and electrical or electromagnetic characteristics 186, in one embodiment. Additional data may also be collected. Based on the collected sensor data, feedback control system 170 controls function generator 160 and gas flow rate 120, and other gas admixture flow to the plasma source 110. In this way, the low temperature plasma system 100 is used to interact with the incident material 140.

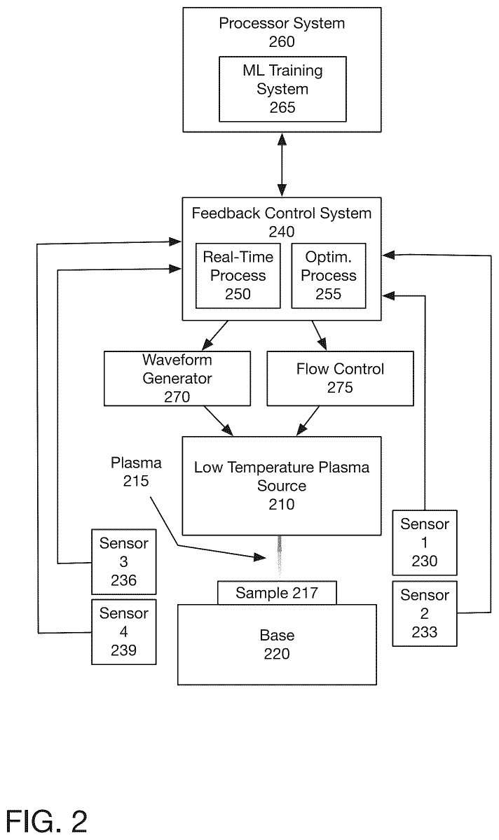

FIG. 2 is an overview block diagram of one embodiment of a control system for plasma. The low temperature plasma source 210 receives applied voltage and frequency via waveform generator 270, which is controlled by feedback control system 240. The waveform generator 270 can be configured to generate different forms of voltage signals across a large range of frequencies, to control applied voltage and frequency for the low temperature plasma source. The low temperature plasma source 210 produces plasma 215 which is incident on a sample 217. In one embodiment, the sample rests on a base 220. Sensors (here shown as sensors 1-4 230, 233, 236, 239) monitor the plasma 215 and sample 217. In one embodiment, one or more of the sensors may be sensing characteristics of the plasma 215. In one embodiment, one or more of the sensors may be sensing characteristics of the sample 217. In one embodiment, one or more of the sensors may be sensing characteristics of the plasma-sample interactions. Although four sensors are shown here, an implementation may include one or more sensors.

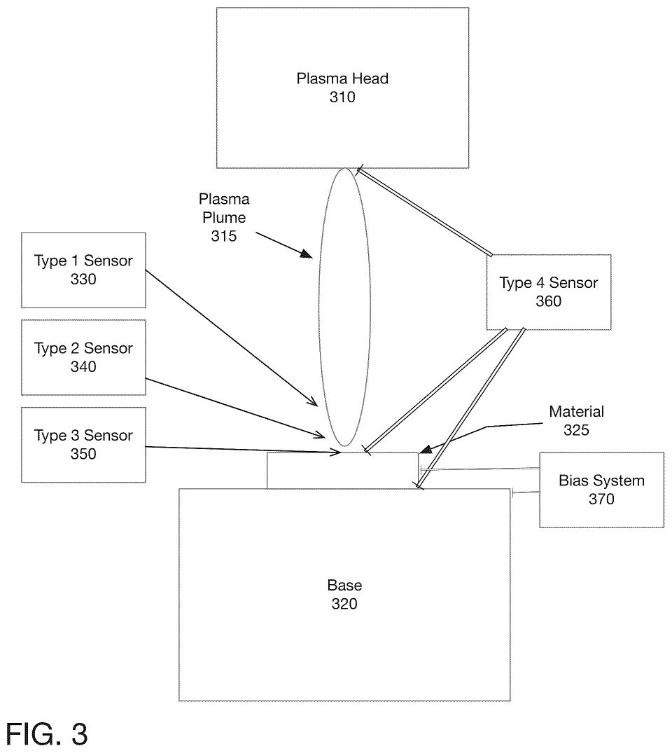

FIG. 3 illustrates one embodiment of the configuration of various types of sensors. The plasma head 310 produces a plasma plume 315, which interacts with a material 325 on a base 320. In one embodiment, the sensors may be used to measure physical, optical, chemical, thermal, electrical, and/or electro-magnetic measurements of the plasma, the plasma-material interface, and/or the material.

A first type of sensor 330 may be a sensor to measure the optical intensity of the plasma. In one embodiment, the sensor 330 making the optical intensity measurement may be an optical emissions spectrometer. The optical emission spectrometer can (indirectly) provide information about the chemical characteristics of the material. In one embodiment, the first type of sensors may measure the optical intensity of the plasma plume 315 itself. The first type of sensor 330 may be a sensor to measure the optical intensity of the plasma at the point where the plasma plume 315 is incident on the material 325. The optical intensity measurement by the first type of sensor 330 may include multiple sensors to take multiple measurements at various positions with respect to the plasma plume 315 and the material 325.

The second type of sensor 340 is an image sensor to take an image of the plasma. The image sensor may take an image of the plasma plume 315, the plasma at the point it is incident on the material 325, etc.

The third type of sensor 350 is to measure the thermal response of the material sample. In one embodiment, an infrared camera may be used as the third type of sensor 350. In another embodiment, one or more of a thermal camera, Raman spectroscopy, near-wave infrared sensor, or short wave infrared sensor are used to take measurements of the material. The thermal response can be indicative of the bulk properties of the material sample.

The fourth type of sensor 360 may be a sensor to measure electrical characteristics of the region. The electrical characteristic measurement may be made by a Root Mean Square (RMS) voltage sensor, a waveform voltage sensor, an RMS current sensor, and/or a waveform current sensor. The fourth type of sensor may also measure the responding waveform inside the material, which can be indicative of the bulk properties of the material sample. In one embodiment, the fourth type of sensor 360 may be coupled to the plasma head 310 and the base 320, to measure a differential voltage or current.

In one embodiment, a bias may be applied to the material 325, base 320, or plasma plume 315 to direct the electrical effects of plasma via bias system 370. If such a bias system is used, the applied bias may be read by another sensor. Biasing may also be used to direct the plasma plume. Biasing in one embodiment can improve the collection of electrical data.

The fourth type of sensor 360 may be an electromagnetic sensor to measure the electromagnetic characteristics of the region. In one embodiment, the electromagnetic sensor may be an inductive sensor such as ultraviolent-visible spectroscopy sensor to measure visible and UV radiation of the region.

The sensors may also include various types of cameras, including one or more of a hyperspectral camera, a line-scan camera, an Ultraviolet (UV) camera, a visible range camera, a near infrared camera, a shortwave infrared camera, a longwave infrared camera, or a Raman spectroscopy camera.

Other types of sensors may include sensors to measure electromagnetic intensity of the plasma or the material, photonic intensity of the plasma or the material. Some exemplary sensors that may be used include: Atomic force microscope (AFM), Atomic force microscope (AFM) nanoindentation, BET analyzer, Brinell hardness tester, Capacitance meter, Capacitance-based sensor, Charged-coupled device (CCD) camera, Complementary metal-oxide-semiconductor (CMOS) (and Scientific CMOS) Detector, Complementary metal-oxide-semiconductor camera (CMOS), Compression tester, Conductive atomic force microscope (AFM), Conductivity meter, Contact angle goniometer, Dielectric spectrometer, Differential scanning calorimeter (DSC), Dilatometer, Dynamic mechanical analyzer (DMA), Electrometer, Electron backscatter diffraction (EBSD), Electron Energy Analyzer, Electron multiplied charged-coupled device (EMCCD), Electrostatic voltmeter, Ellipsometer, Energy-dispersive X-ray spectroscopy (EDS), Falling ball viscometer, Fluorometer, Four-point probe, Gas adsorption analyzer (e.g., Hall effect sensor, Hyperspectral camera, Impedance analyzer, Infrared camera, Infrared spectroscope, Interferometric dilatometer, Inverse gas chromatography (IGC), Isothermal calorimeter, Kelvin probe, Kelvin Probe Force Microscopy (KPFM), Langmuir Probe, Laser displacement sensor, Laser flash analysis, Laser scattering probe (e.g., Thompson scatter probe), Long-wave infrared (LWIR) sensor, Luminescence microscope, Luminescence spectroscope, Magnetic force microscope (MFM), Magnetic susceptibility balance, Mass spectrometer, Melting point apparatus, Mercury porosimeter, Mid-wave infrared (MWIR) sensor, Multichannel spectroscopy, Nano-mechanical tester, Neutron diffraction, NMOS Detector, Nonlinear optical microscope, Nonlinear optical spectroscope, Nuclear magnetic resonance (NMR) spectrometer, Optical fiber spectrometer, Optical interferometer, Optical microscope with high magnification, Optical spectrum analyzer, Peel tester, Pendant drop method, Phosphor screen, Photomultiplier tube, Profilometer, Pull-off adhesion tester (e.g., Raman Microscope, Raman Spectroscope, Reaction calorimeter, Reflectometer, Rockwell hardness tester, rotational or capillary), Scanning electron microscope (SEM), Scratch tester, Secondary ion mass spectrometry (SIMS), Short-wave infrared (SWIR) sensor, Spectrofluorometer, Spectrophotometer, SPR biosensor, SPR imaging, SQUID magnetometer, Streak camera, Surface energy analyzer, Surface plasmon resonance (SPR) spectroscopy, tensile or shear), Tensile tester, Tensiometer, Thermal conductivity meter, Thermal desorption spectroscopy (TDS), Thermal mechanical analyzer (TMA), Thermogravimetric analyzer (TGA), Thermomechanical analyzer (TMA), Time-resolved microscope, Time-resolved spectroscope, Transient plane source (TPS) method, Transmission electron microscope (TEM), Two-dimension optical spectroscope, Two-dimensional optical microscope, Universal testing machine (UTM), UV-Vis-NIR spectrometer, Van der Pauw method, Vibrating sample magnetometer (VSM), Vibrational viscometer, Vickers hardness tester, Viscometer (e.g., White light interferometer, Wilhelmy plate method, X-ray diffraction (XRD), X-ray photoelectron spectroscopy (XPS), etc.

Returning to FIG. 2, the feedback control system 240 receives the sensor data from sensors 230, 233, 236, 239. The feedback control system 240 performs calculations based on the sensor data, and outputs control signals to waveform generator 270 and flow control 275 to adjust the low temperature plasma source 210. The feedback control system 240 infers the power level of the plasma 215, compares this “measured” power with a power setpoint, and outputs applied voltage and frequency to the waveform generator 270 to regulate the plasma power.

The feedback control system 240 in one embodiment includes a real-time process 250 which utilizes a deep neural network based model predictive control (MPC) system, or a robust or stochastic variant of MPC. In one embodiment, an embedded multiloop proportional-integral-derivative (PID) control system is used. In another embodiment, the real-time process may use an MPC system that is not based on a deep neural network. In one embodiment, the feedback control system 240 is configured to iteratively adjust parameters of the low temperature plasma source to bring an interaction of the plasma with the material sample closer to a desired interaction, each iteration comprising receiving feedback from one or more of the plurality of sensors, the feedback indicative of the interaction of the plasma with the material sample; and adjusting, based on the feedback, one or more parameters of the low temperature plasma source.

The inputs to the real time process 250 are the goals (e.g., desired plasma settings) and the sensor data from the various sensors. The output of the real time process 250 are control signals for the low temperature plasma source, including controls for the waveform generator 270 and flow control 275. By using the deep neural network based MPC system, the real-time process 250 can provide rapid adjustments to the plasma source 210. In one embodiment, the adjustment is sub-second, also referred to as real-time.

Furthermore, the real-time process 250 has a small memory footprint, is cheap to evaluate, and can be run on an embedded system or on resource-limited hardware. The deep neural network approximation of the MPC replaces the online optimization problem with an explicit constrained multivariable control law, which can be rapidly and cheaply evaluated, to provide real-time control. The real-time process 250 is trained and optimized specifically for the control objective, e.g., controlling the spatially distributed and nonlinear/cumulative effects of plasma on the sample 217.

The feedback control system 240 also includes an optimization process 255 in one embodiment. In one embodiment, the optimization process 255 also receives sensor data, and uses the sensor data to evaluate the plasma effects on the sample 217 to adapt the parameters of the real-time process 250. In another embodiment, the optimization process 255 may receive processed data in addition to or instead of the raw sensor data. The optimization process 255 in one embodiment utilizes a Bayesian optimization to evaluate the functioning of the real-time process and adjust the real-time process. In one embodiment, when no deep neural network is used, the optimization process 255 can directly tweak the parameters and cost function of the MPC used by the real-time process 250 to address drifting or other issues. When the real-time process 250 is based on a deep neural network approximation of the MPC, the parameters of the deep neural network are adapted based on the input from the optimization process 255. The optimization process 255 is slower than the real-time process 250. The optimization process 255 in one embodiment is on a run-to-run basis, evaluating the performance of the plasma source 210 and the real-time process 250 after the completion of the plasma process run. In another embodiment, the optimization process 255 may be active during the plasma process, but on a slower basis. The optimization process 255 in one embodiment receives sensor data from sensors that quantify the cumulative plasma effect on the material, which are not measured in real-time.

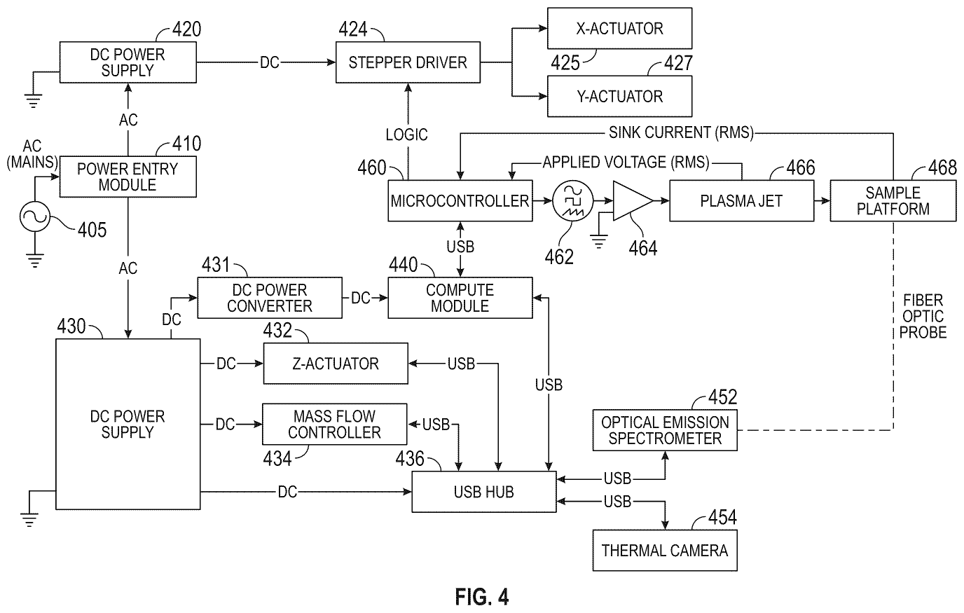

FIG. 4 is a circuit diagram of one embodiment of the low temperature plasma system. The embodiment shown includes various components in a specific configuration to demonstrate various principles that aid in providing a low-temperature plasma jet with stable power output. Other embodiments of the low-temperature plasma control system may include different or additional components and control of other plasma variables and surface effects. Furthermore, the elements may be arranged in a different manner than described.

In the embodiment shown, a power entry module 410 receives input power and distributes it to the remainder of the system. The input power is shown as alternating current (AC) mains power (e.g., 120V in the US or 220-240V in much of Europe, etc.). The power entry module 410 distributes mains power to a first DC power supply 420 and a second DC power supply 430, each of which convert the provided AC to direct current (DC) at an operating voltage (e.g., 24V). However, the power input may be provided from sources other than the mains, such as a high-capacity battery. In which case, conversion to DC and voltage adjustment may not be required.

The first DC power supply 420 powers a stepper driver 424, in one embodiment. The stepper driver 424 generates drive signals for an X-actuator 425 and a Y-actuator 427 that move the plasma jet 466 in the X and Y directions, respectively. In this context, the X and Y directions are the pair of axes that are substantially parallel with a surface being evaluated (which is mounted on a sample platform 468). In one embodiment, stepper driver 424 generates the drive signals based on instructions received from a microcontroller 460. Alternatively, the X-actuator 425 and/or Y-actuator 427 may move the sample platform 468 relative to the plasma jet 466 (e.g., with the plasma jet remaining stationary). In one embodiment, TB6600 stepper motor drivers are used as actuators 425, 427. It should be appreciated that a wide range of actuators may be used, including actuators that do not have separate controls for X and Y motion (e.g., robot arms).

The second DC power supply 430 in one embodiment powers a DC power converter 431, a Z-actuator 432, a mass flow controller 434, and a USB hub 436. The DC power converter 431 changes the DC voltage provided by the second DC power supply 430 to a voltage used by a compute module 440 (e.g., 5V). For example, the compute module 440 may be a single board computer such as a Raspberry Pi 4B. The Z-actuator moves the assembly on which the plasma jet 466 is mounted in the z-axis (i.e., substantially towards or away from the sample surface). The mass flow controller 434 controls the rate of flow of gas (e.g., helium) to the plasma jet 466. The USB hub 436 provides connectivity between (and in some cases power to) various components of the system, in one embodiment.

The compute module 440 provides control signals to the Z-actuator 432 and the mass flow controller 434. In addition, the computer module 440 serves as an interface with the user and controls other peripheral devices, such as OES 452 and thermal camera 454. In FIG. 4, the computer module 440 is connected to the sensors via the USB hub 436, but some or all of the sensors may be connected directly to the computer module 440. The compute module 440 may also provide instructions and/or receive data from the microcontroller 460 via a separate connection. For example, the computer module 440 may provide instructions for operation of signal generator 462, X-actuator 425, and/or Y-actuator 427 indirectly via the microcontroller 460.

The plasma jet 466 is controlled by the microcontroller 460. It should be appreciated that the term plasma jet 466 is used for convenience but any type of plasma source may be used. In one embodiment, microcontroller 460 is an Arduino UNO R3, however, other types of microcontrollers 460 may be used. Regardless of the specific microcontroller 460 used, the microcontroller implements the real-time process, and causes a signal generator 462 to generate a waveform at a predetermined frequency (e.g., 1 kHz). In one embodiment, signal generator 462 is an AD9850 digital direct synthesis (DDS) module. The output from a typical signal generator 462 is not sufficient to ignite the plasma jet 466, so the output from the signal generator 462 is amplified by amplifier 464. In one embodiment, the amplifier 464 includes a pre-amplification circuit and a high-voltage amplifier.

Once the plasma jet 466 is ignited by the power applied by the amplifier 464, the microcontroller 460 receives feedback from one or more feedback sensors. In one embodiment, the feedback includes the root-mean-squared (RMS) applied voltage and the RMS sink current. The variance in the voltage and current are due to the sensitivity of plasma to environmental factors and sample. The system seeks to keep the power constant using the controller to “reject” these disturbances. From the RMS voltage and RMS current, the applied power can be calculated and compared to a predetermined setpoint (e.g., as provided by the user). Alternatively, the setpoint may be determined dynamically based on feedback from one or more sensors to provide a desired interaction between the generated plasma and the sample. In one embodiment, the RMS voltage sensor and/or RMS current sensor uses the AD736KNZ RMS-to-DC converter. Because the RMS voltage and/or current sensor is embedded, in one embodiment, it can provide voltage measurements to the microcontroller 460 rapidly (e.g., on millisecond to microsecond timescales).

In one embodiment, the current measured is the current created between the electrode of the plasma jet 466 and the sample platform 468 as a result of the plasma plume from the plasma jet 466. This current is equal to the current flowing through a wire connecting the sample platform 468 to the ground of the high voltage amplifier 464. The current may be measured by measuring the voltage across a resistor on this wire connecting the plate to the ground of the amplifier 464, which can be used to calculate the current from the known resistance of a resistor.

Regardless of the precise feedback circuitry used, the control signal provided by the microcontroller 460 to the signal generator 462 can be modified to bring the applied power closer to the setpoint (i.e., if the applied power is less than the setpoint then the amplitude of the voltage signal generated may be increased and vice versa). Adjustments may additionally or alternatively adjust the gas flow to the plasma jet 466. Thus, a real-time feedback control loop is established that can keep the applied power close to the setpoint, automatically compensating for any environmental disturbances or other factors that impact the applied power. This enables more accurate control of the interactions between the low-temperature plasma and the material. For example, surface characterizations in a metrology embodiment can be more accurate because detected variations in the interactions between the surface and the plasma jet 466 are more likely to be due to the characteristics of the surface than changes in the plasma behavior. Similarly, surface modifications or treatments made by the low-temperature plasma may be more precise because the power output has greater consistency, enabling finer control of the surface modifications made.

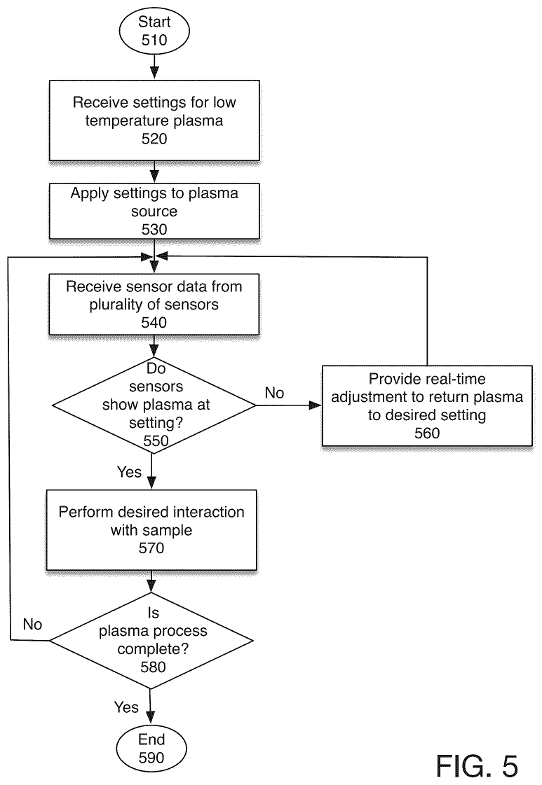

FIG. 5 is an overview flowchart of one embodiment of using the low temperature plasma system. The process starts at block 510. At block 520, the settings for the low temperature plasma are received. The settings in one embodiment specify the voltage signal, gas mixture, and distance of the plasma jet from the material.

At block 530, the settings are applied to the plasma source, and the plasma plume is initiated. In one embodiment, the plasma plume settles after a few seconds.

At block 540, sensor data is received from a plurality of sensors monitoring the plasma plume and/or the material on which the plasma plume is operating. The sensors that provide data may include voltage sensors, current sensors, optical sensors, infrared sensors, temperature sensors, cameras, and other sensors. The sensors may be directed at the plasma plume, the interface between the plasma and the material, and/or the material.

At block 550, the process determines whether the sensors indicate that the plasma is maintaining the settings based on the data from the sensors. If the analysis of the sensor data indicates that the plasma is no longer at the setting, at block 560, a real-time adjustment is provided to the plasma source to return the plasma to the desired setting. In one embodiment, the adjustment may be to the power level provided to the plasma source. The adjustment may instead, or additionally, be to the gas mixture for the plasma source. The adjustment may instead or additionally be to the distance between the plasma source and the material.

The process then returns to block 540 to continue receiving sensor data and continue monitoring. This loop in one embodiment is a closed loop monitoring which provides real-time adjustments to the plasma settings.

If the sensor data indicates that the plasma remains at the set point, at block 570 the desired interaction with the sample material is performed. The desired interaction may be metrology, measuring characteristics of the material, plasma etching, modifying the material using the plasma, etc.

At block 580, the process determines whether the plasma process is complete. This may be determined based on time, e.g., after a certain amount of time. The determination may be based on a certain amount of data acquired, e.g., after the characterization is complete. The determination may be based on data from sensors, e.g., a certain depth of etching or pattern completed. if the process is not yet complete, the process returns to block 540, to continue receiving sensor data. If the process is complete, the process ends at block 590.

Although FIG. 5 is illustrated as a flowchart, one of skill in the art would understand that it may be implemented as an interrupt driven system. In such a system, the sensor monitoring of block 550, adjustments of block 560 are continuous and occur in parallel with the plasma process of block 570 and the monitoring to determine whether the process is complete.

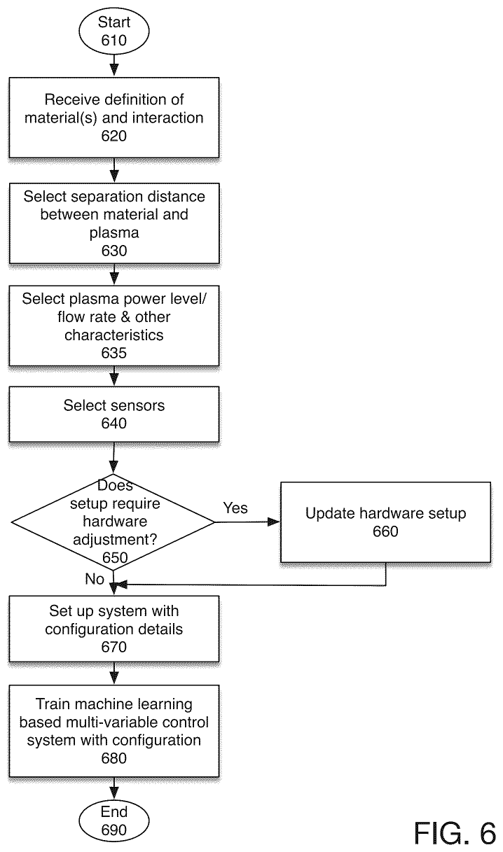

FIG. 6 is a flowchart of one embodiment of setting up the low temperature plasma system. The process starts at block 610.

At block 620, the definition of the material and intended interaction is received. The definition of the material indicates the sample on which the plasma system will be working. The material may be a thin film, metallic material, a biologic material, or another type of material. The material definition in one embodiment may also include other characteristics such as uniformity, thickness, etc. The intended interaction defines the use of the plasma in this configuration. As noted above, the interaction may treat, modify, etch, or characterize the material. The modification of the material may include cleaning the material, altering the material characteristics through the plasma exposure, etc.

At block 630, the separation distance between the plasma plume and the material is selected. This is selected based on the material being evaluated, as well as the intended interaction.

At block 635, the plasma power level, gas flow rate, and other characteristics of the plasma are selected. In one embodiment, the separation and plasma characteristics are selected in conjunction with each other.

At block 640, the sensors to be used are selected. The sensors, in one embodiment, may vary based on the material, set-up, and intended interaction. For example, some configurations may use two optical emission spectrometers to monitor the bulk of the plasma plume and at the interface between the plasma and the material. Some configurations may use additional imaging sensors. For some configurations, additional voltage sensors may be used to monitor the biasing of the material or the base on which the material rests. The configuration, at a minimum, includes two sensors. In one embodiment, the two sensors include a voltage or current sensor and a camera, which may use visible light, infrared, or another spectrum range.

At block 650, the process determines whether the setup defined, e.g., the separation distance, plasma characteristics, and sensors require hardware adjustment. Hardware adjustment may be altering the configuration of the plasma set-up. The set-up includes positioning for the plasma source as well as the sensors. In one embodiment, hardware adjustments may also include setting up a biasing for the material being tested or a base on which the material is positioned. If hardware adjustment is needed, at block 660, the hardware set up is updated to support the configuration.

At block 670, the system is set up with the configuration details.

At block 680, a machine learning-based multivariable control system is trained with the configuration specifics. The machine learning-based multivariable control system is trained for the specific hardware configuration. In one embodiment, the machine learning-based multivariable control system is specific to the setup of the system, including the hardware configuration, plasma configuration, material, and interaction. In one embodiment, the machine learning-based multivariable control system is specifically trained for the setup. This can be done offline, and not in real-time. Once the machine learning-based multivariable control system is trained, it embeds a functional approximation of a controller, such as model predictive control (MPC) discussed above, to provide the real-time closed loop control for the plasma. In one embodiment, the functional approximation is a deep neural network, as discussed above.

This replaces a complex optimization problem with a function that is cheap and can be solved in real-time. The function can be used to control the physical output of the plasma based on sensor data, in real-time. This provides a cheap to evaluate and low memory footprint method of real-time control. As discussed above, this is enhanced, in one embodiment, by a second layer of a slower optimization controller which adjusts the parameters used by the real-time controller.

The process then ends at block 690.

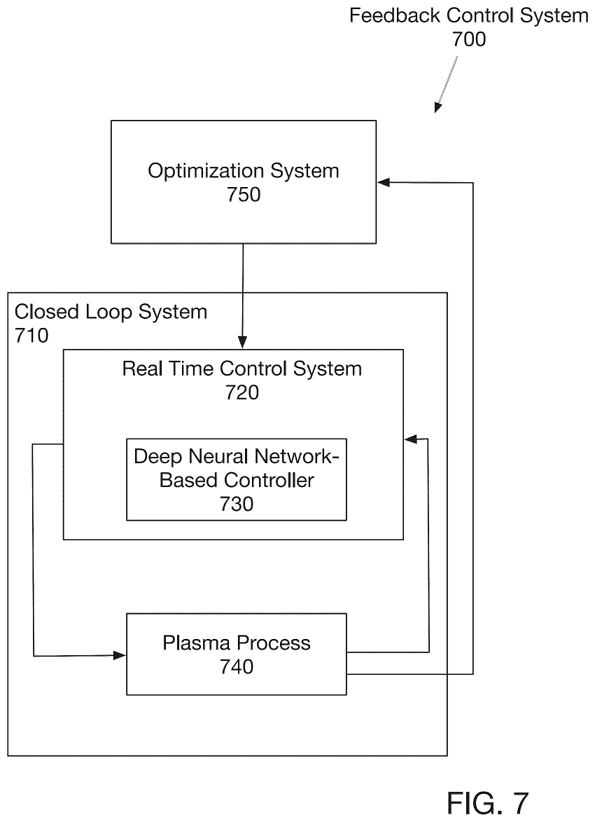

FIG. 7 is a diagram of one embodiment of the feedback control system 700 which provides a two layer hierarchical control system for the low temperature plasma. The deep neural network based controller 730 is part of a real-time control system 720 and is in a closed-loop system 710 with the plasma process 740. The real-time control system 720 provides controls to adjust the applied voltage, frequency, gas flow rate, and gas mixture for the plasma source. The plasma process provides feedback to the real-time control system 720. The feedback is the data from the sensors monitoring the plasma plume and its effect on the sample. This closed loop system 710 provides the real-time, low overhead, and locally implemented controls.

Optimization system 750 provides data-driven optimization to determine control policy parameters of the real-time control system. The optimization system 750 also receives sensor data, in one embodiment. In one embodiment, the sensor data for the optimization system 750 is data to quantify the plasma effects on the surface of the material. This data is not real-time. The optimization system 750 utilizes the feedback from the sensors to monitor the parameters used by the real-time control system 720. The optimization system 750 in one embodiment uses a Bayesian optimization and provides adjustments to the parameters of the deep neural network based controller 730. The optimization system 750 in one embodiment uses reinforcement learning, in addition to Bayesian optimization. The output of optimization system 750 provides the control policy parameters for the real-time control system 720. The control policy parameters can comprise one or more of model, constraint, and objective function parameterizations of the real-time control system.

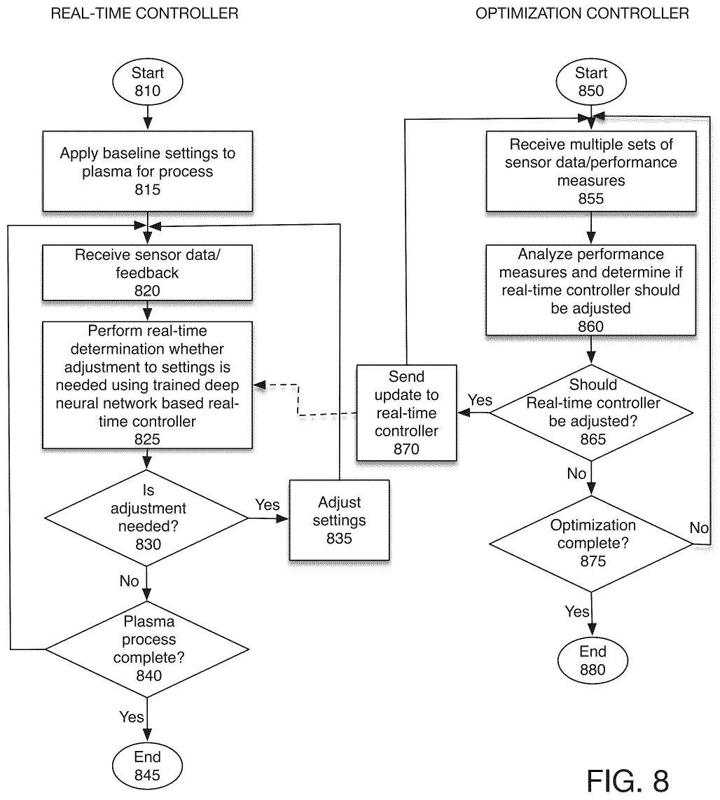

FIG. 8 is a flowchart of one embodiment of using the hierarchical control system. There are two parallel flows, one for the real-time controller, and one for the optimization controller. The flowchart portion on the left is the real-time controller while the flowchart portion on the right is the optimization controller. Although these flows are illustrated as sequential flowcharts, one of skill in the art should understand that the ordering of specific blocks may be altered if they are not dependent on each other. Furthermore, decisions may be interrupt driven and occur at any time.

The real-time controller flowchart starts at block 810. At block 815, the baseline settings are applied to the plasma for the process. The baseline settings are the applied voltage, frequency, and gas flow for the plasma. The baseline settings also may include the setup details, such as the distance between the plasma source and the material, biasing, etc. The plasma starts, and the plasma process starts at this point.

At block 820, sensor data is received from the sensors monitoring the plasma and material. In one embodiment, sensor data is received continuously. In another embodiment, sensor data may be received periodically. The period would be sub-second, in one embodiment.

At block 825, the real-time controller performs real-time determination whether adjustment to the settings is needed. In one embodiment, the deep neural network based real-time controller is used to control the output of the plasma by manipulating its inputs.

If adjustment is needed, as determined at block 830, the settings are adjusted at block 835. At block 840, the process determines whether the plasma process is complete. If so, the process ends at block 845. Otherwise, the process returns to block 820 to continue monitoring and adjusting the plasma.

The optimization controller process is started at block 850. In one embodiment, the optimization controller process may run concurrently with the real-time controller process. In another embodiment, the optimization controller process may be on a run-on-run basis, evaluating the real-time controller's performance after completion of the plasma process.

The optimization controller receives multiple sets of sensor data and performance measures, at block 855. In one embodiment, the optimization controller receives the same raw sensor data as the real-time controller. In one embodiment, the optimization controller may additionally, or instead, receive data that is not accessible to the real-time controller. Such data may have a slower measurement frequency than what is needed for effective real-time control, or “offline” after each process run. For example, the optimization controller may receive data that quantifies plasma effects on the surface, or characterizes the chemistry of the material that was treated with the plasma.

At block 860, the optimization controller analyzes the performance measures to determine whether the real-time controller should be tweaked. The real-time controller should be adjusted to adapt to the drift or variability, to improve performance. If the system determines that the real-time controller should be tweaked at block 865, at block 870 one or more updated parameters are sent to the real-time controller. In one embodiment, this may be done during the plasma process, to take effect immediately. In another embodiment, this may be done at the end of the plasma process, for subsequent processing.

At block 875, the process determines whether the optimization controller evaluation is complete. If not, the process then returns to block 855 to continue receiving data. Otherwise, the process ends at block 880.

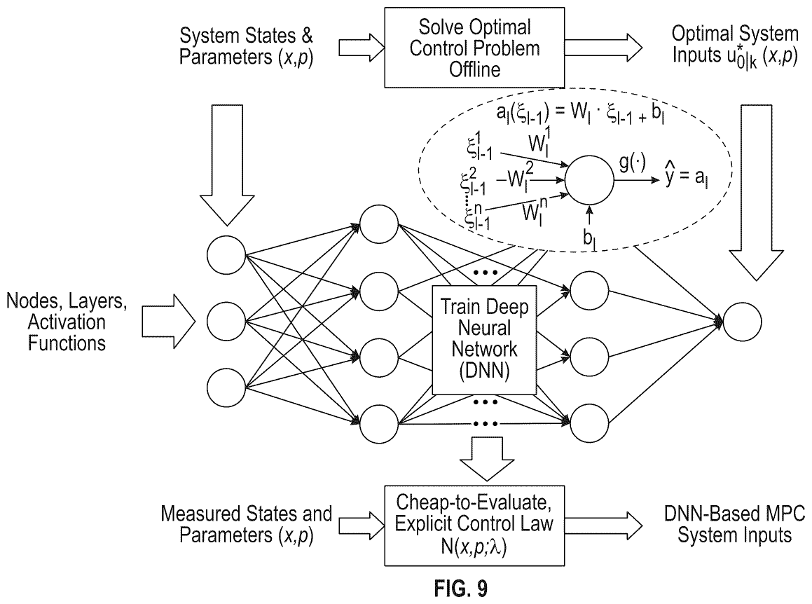

FIG. 9 is a diagram of one embodiment of the training for a deep neural network that may be used with the low temperature plasma system. The system states and parameters are used as inputs to train a deep neural network (DNN) to produce optimal system inputs to control the plasma source. The result of the DNN's training is a cheap to evaluate explicit control law, which can be implemented in low cost hardware and used to provide the real-time control signals based on measured process variables and plasma effects on a sample.

In one embodiment, the training process first solves the MPC problem in a closed loop to gather training data for approximating the initial control law. In one embodiment, the process sets a prediction horizon Np=5, the robust horizon Nr=2, and the discrete uncertainty scenarios as [0.01 Wₘᵢₙ, 0, 0.01 Wₘₐₓ]. The control inputs are constrained by Pϵ[1.5, 5] W and qϵ[1.5, 5] SLM, and the states are constrained by Tϵ[25, 45]° C. and Iϵ[20, 80] arb. units. The MPC in one embodiment is formulated using the CasADi open source non-linear optimization tool and solved with IPOPT “Interior Point OPTimizer” library. A simulation of the true system with a mismatch between the plant and control model and normally distributed measurement noise N (0, (0.1)²). A total of nₛ=5,000 samples of state-to-optimal-input mappings were collected, and used to train a fully-connected feedforward Deep Neural Network (DNN) architecture with L=4, H=7, and ReLU (rectified linear unit) activation functions. The DNN underwent training for 5,000 epochs using PyTorch with the default optimizer settings. The resulting DNN-based policy achieved nearly equivalent performance to the implicit MPC law. Furthermore, the computation time of the DNN, which depends on the architecture of the DNN, compared to solving the optimization equation, on a standard CPU (2.4 GHz quad-core Intel i5 processor) was roughly three orders of magnitude faster (˜10-5 s versus ˜10.2 s). Thus, the trained system could perform in real-time.

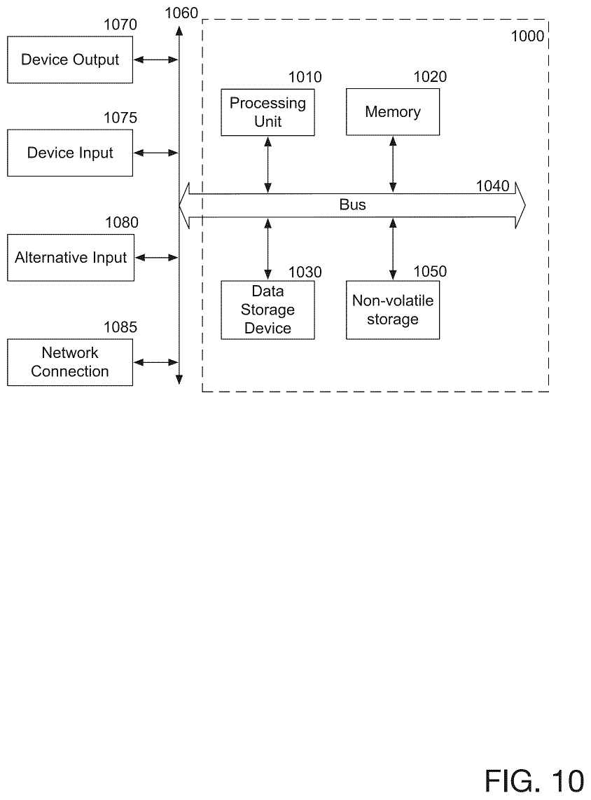

FIG. 10 is a block diagram of a particular machine that may be used with the present invention. It will be apparent to those of ordinary skill in the art, however that other alternative systems of various system architectures may also be used.

The data processing system illustrated in FIG. 10 includes a bus or other internal communication means 1040 for communicating information, and a processing unit 1010 coupled to the bus 1040 for processing information. The processing unit 1010 may be a central processing unit (CPU), a digital signal processor (DSP), or another type of processing unit 1010.

The system further includes, in one embodiment, a random access memory (RAM) or other volatile storage device 1020 (referred to as memory), coupled to bus 1040 for storing information and instructions to be executed by processor 1010. Main memory 1020 may also be used for storing temporary variables or other intermediate information during execution of instructions by processing unit 1010.

The system also comprises in one embodiment a read only memory (ROM) 1050 and/or static storage device 1050 coupled to bus 1040 for storing static information and instructions for processor 1010. In one embodiment the system also includes a data storage device 1030 such as a magnetic disk or optical disk and its corresponding disk drive, or Flash memory or other storage which is capable of storing data when no power is supplied to the system. Data storage device 1030 in one embodiment is coupled to bus 1040 for storing information and instructions.

The system may further be coupled to an output device 1070, such as a cathode ray tube (CRT) or a liquid crystal display (LCD) coupled to bus 1040 through bus 1060 for outputting information. The output device 1070 may be a visual output device, an audio output device, and/or tactile output device (e.g. vibrations, etc.)

An input device 1075 may be coupled to the bus 1060. The input device 1075 may be an alphanumeric input device, such as a keyboard including alphanumeric and other keys, for enabling a user to communicate information and command selections to processing unit 1010. An additional user input device 1080 may further be included. One such user input device 1080 is cursor control device 1080, such as a mouse, a trackball, stylus, cursor direction keys, or touch screen, may be coupled to bus 1040 through bus 1060 for communicating direction information and command selections to processing unit 1010, and for controlling movement on display device 1070.

Another device, which may optionally be coupled to computer system 1000, is a network device 1085 for accessing other nodes of a distributed system via a network. The communication device 1085 may include any of a number of commercially available networking peripheral devices such as those used for coupling to an Ethernet, token ring, Internet, or wide area network, personal area network, wireless network, or other method of accessing other devices. The communication device 1085 may further be a null-modem connection, or any other mechanism that provides connectivity between the computer system 1000 and the outside world.

Note that any or all of the components of this system illustrated in FIG. 10 and associated hardware may be used in various embodiments of the present invention.

It will be appreciated by those of ordinary skill in the art that the particular machine that embodies the present invention may be configured in various ways according to the particular implementation. The control logic or software implementing the present invention can be stored in main memory 1020, mass storage device 1030, or other storage medium locally or remotely accessible to processor 1010.

It will be apparent to those of ordinary skill in the art that the system, method, and process described herein can be implemented as software stored in main memory 1020 or read only memory 1050 and executed by processor 1010. This control logic or software may also be resident on an article of manufacture comprising a computer readable medium having computer readable program code embodied therein and being readable by the mass storage device 1030 and for causing the processor 1010 to operate in accordance with the methods and teachings herein.

The present invention may also be embodied in a handheld or portable device containing a subset of the computer hardware components described above. For example, the handheld device may be configured to contain only the bus 1040, the processor 1010, and memory 1050 and/or 1020.

The handheld device may be configured to include a set of buttons or input signaling components with which a user may select from a set of available options. These could be considered input device #1 1075 or input device #2 1080. The handheld device may also be configured to include an output device 1070 such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above, such as a kiosk or a vehicle. For example, the appliance may include a processing unit 1010, a data storage device 1030, a bus 1040, and memory 1020, and no input/output mechanisms, or only rudimentary communications mechanisms, such as a small touchscreen that permits the user to communicate in a basic manner with the device. In general, the more special purpose the device is, the fewer of the elements need be present for the device to function. In some devices, communications with the user may be through a touch-based screen, or similar mechanism. In one embodiment, the device may not provide any direct input/output signals but may be configured and accessed through a website or other network-based connection through network device 1085.

It will be appreciated by those of ordinary skill in the art that any configuration of the particular machine implemented as the computer system may be used according to the particular implementation. The control logic or software implementing the present invention can be stored on any machine-readable medium locally or remotely accessible to processor 1010. A machine-readable medium includes any mechanism for storing information in a form readable by a machine (e.g. a computer). For example, a machine readable medium includes read-only memory (ROM), random access memory (RAM), magnetic disk storage media, optical storage media, flash memory devices, or other storage media which may be used for temporary or permanent data storage. In one embodiment, the control logic may be implemented as transmittable data, such as electrical, optical, acoustical, or other forms of propagated signals (e.g. carrier waves, infrared signals, digital signals, etc.).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

We claim:

1. A plasma system comprising:
a low temperature plasma source incident on a material sample;
a plurality of sensors that measure a plurality of different characteristics of a region of the low temperature plasma source and the material sample;
a feedback control system that receives measurements from the plurality of sensors and adjusts inputs to the low temperature plasma source to control one or more of electrical, electromagnetic, chemical, or thermal characteristics of a plasma generated, at a sub-second rate.

2. The plasma system of claim 1, further comprising:
one or more additional sensors to measure one or more of the material sample characteristics, wherein the characteristics include one or more of surface and bulk characteristics.

3. The plasma system of claim 2, wherein the one or more additional sensors measure one or more of physical, electrical, electromagnetic, chemical, or thermal characteristics of the material sample.

4. The plasma system of claim 1, wherein the plurality of sensors includes a sensor to measure electrical characteristics of one or more of: the plasma and the material sample.

5. The plasma system of claim 4, wherein the sensor to measure electrical characteristics comprises one or more of: a Root Mean Square (RMS) voltage sensor, a waveform voltage sensor, an RMS current sensor, or a waveform current sensor.

6. The plasma system of claim 1, wherein the plurality of sensors includes a sensor to measure one or more of: an optical intensity and electromagnetic emissions of the plasma.

7. The plasma system of claim 6, further comprising:
a first sensor to measure the optical intensity of the plasma above the material sample; and
a second sensor to measure the optical intensity of the plasma at a point where the plasma is incident on the material sample.

8. The plasma system of claim 1, wherein the plurality of sensors includes an image sensor, to take an image of the sample.

9. The plasma system of claim 1, wherein the plurality of sensors includes one or more of a thermal imaging sensor, an UV-Vis spectrometer, a camera, a hyperspectral camera, a line-scan camera, an Ultraviolet (UV) camera, a visible range camera, a near infrared camera, a shortwave infrared camera, a longwave infrared camera, or a Raman spectroscopy camera to take measurements of the characteristics of the material sample.

10. The plasma system of claim 1, wherein the feedback control system comprises a hierarchical system including:
a real-time control system to modulate plasma processes in real-time based on measurement feedback from the plurality of sensors, and
an optimization system to adjust elements of the real-time control system based on the measurement feedback from the plurality of sensors.

11. The plasma system of claim 10, wherein the measurement feedback comprises measurement of one or more of: characteristics of the plasma and characteristics of the material sample.

12. The plasma system of claim 10, wherein the real-time control system comprises a trained machine learning based controller to receive measurements from the plurality of sensors and provide control signals to the low temperature plasma source to control spatially distributed and nonlinear/cumulative chemical, thermal, electromagnetic, and electrical interactions of the plasma with the material sample.

13. The plasma system of claim 10, wherein the real-time control system is implemented as an embedded controller on resource-limited hardware, and wherein the embedded controller includes at least one of: an embedded multiloop PID control system, an embedded model predictive controller, a robust and stochastic model predictive controller, or an embedded approximate model predictive controller using deep learning and machine learning methods.

14. The plasma system of claim 10, wherein the real-time control system uses a machine learning-based approximation of a model predictive controller.

15. The plasma system of claim 10, wherein the optimization system comprises a data-driven optimization method to determine control policy parameters of the real-time control system.

16. The plasma system of claim 15, wherein the control policy parameters can comprise one or more of model, constraint, and objective function parameterizations of the real-time control system.

17. The plasma system of claim 1, further comprising:
the feedback control system configured to control one or more of: applied voltage, frequency, gas flow, and other gas admixture flow to the low temperature plasma source, and distance between the plasma and the material sample.

18. The plasma system of claim 17, further comprising:
a waveform generator for generating different forms of voltage signals across a large range of frequencies to control applied voltage and frequency for the low temperature plasma source.

19. The plasma system of claim 18, wherein an output of the waveform generator is based on direct digital synthesis.

20. The plasma system of claim 1, further comprising:
a bias system to apply one of a voltage bias or a current bias to one or more of the material samples and a base on which the material sample is placed.

21. The plasma system of claim 1, wherein the low temperature plasma source is configured to treat, modify, etch, or characterize the material sample.

22. The plasma system of claim 1, wherein the feedback controller is configured to iteratively adjust parameters of the low temperature plasma source to bring an interaction of the plasma with the material sample closer to a desired interaction, each iteration comprising:
receiving feedback from one or more of the plurality of sensors, the feedback indicative of the interaction of the plasma with the material sample; and
adjusting, based on the feedback, one or more parameters of the low temperature plasma source.

23. The plasma system of claim 1, wherein the low temperature plasma source is a cold atmospheric plasma source producing a low temperature plasma close to room temperature and at atmospheric pressure.

24. A method of using a plasma system comprising:
directing a low temperature plasma source incident on a material sample;
measuring a plurality of different characteristics of the material, including one or more of surface characteristics and bulk characteristics, using a plurality of sensors, when the low temperature plasma source is incident on the material sample;
receiving measurements from the plurality of sensors at a feedback control system;
adjusting inputs to the low temperature plasma source by the feedback control system to control one or more of electrical, electromagnetic, chemical, or thermal characteristics of a plasma generated at a sub-second rate.
